(19) United States
(12) Patent Application Publication
(10) Pub. No.: US 2025/0347306 A1
(43) Pub. Date: Nov. 13, 2025

(54) A FASTENER ELEMENT, A TOOL AND A FASTENER SYSTEM FOR FASTENING BOARDS TO A FRAME STRUCTURE

(71) Applicant: ESSVE Produkter AB, Kista (SE)

(72) Inventor: Stefan Carlsson, Upplands Väsby (SE)

(21) Appl. No.: 18/872,797

(22) PCT Filed: Jun. 7, 2023
(86) PCT No.: PCT/SE2023/050572

§ 371 Date: Dec. 6, 2024

(30) Foreign Application Priority Data
Jun. 10, 2022 (SE) 2250702-4

(51) Int. Cl. F16B 15/00; E04F 21/18

(52) U.S. Cl. CPC F16B 15/0015; E04F 21/18

(57) ABSTRACT

The disclosure relates to a fastener element for fixating boards to a frame structure, the fastener element comprises: a pair of legs each comprising a first end and a second end, and a head, which extends between the legs and which is connected to the first end of each leg, wherein the head of the fastener element has a straight extension and is ductile to a convex arch-shape which during a fastening operation, for driving of the fastener element into the board and frame structure, is ductile to a convex arch-shape; wherein the convex arch-shape of the head has a curved path along the entire extension of the head, and wherein a distance (d1-dn) between any point (P1-Pn) on the head and the second end of each leg increases during the fastening operation. The disclosure further relates to a tool for driving a fastener element into boards and a frame structure. The disclosure further relates to a fastener system for fastening boards to a frame structure.

### TECHNICAL FIELD

The present disclosure relates to a fastener element for fixating boards to a frame structure, a tool for driving a fastener element into boards and a frame structure, and a fastener system for fastening boards to a frame structure. More specifically, the disclosure relates to a fastener element for fixating boards to a frame structure, a tool for driving a fastener element into boards and a frame structure and a fastener system for fastening boards to a frame structure as defined in the introductory parts of the independent claims.

### BACKGROUND ART

Wall constructions may comprise boards and panels, which are secured by fastener elements to a frame structure of studs and beams. The fastener elements may be screws. Alternatively, the boards and panels may be secured to the frame structure by fastener elements, which include a head or bridge portion interconnecting a pair of penetrating leg portions. Such fastener elements may be conventional round wire staples or flat staples having planar upper and lower surfaces.

The boards and panels may be gypsum boards provided with paper surfaces. In order to save the paper surface of the gypsum boards from scarring or tearing, the head of the fastener elements may be provided with a thin layer of plaster or cement. The thin layer of plaster or cement of the head of the fastener element may result in a smooth exposed surface of the gypsum board. Alternatively, the surface of the head on the side which is configured to rest on the board may be provided with a smooth rounded surface.

Document GB793126A discloses a prior art fastener element configured to fastening a gypsum board to a frame structure of a wall. The fastener element comprises a staple with a flat top surfaced crown having legs extending from the ends thereof for penetrating the board and into the frame structure, and an underlying surface which, in cross-section, is of greatest thickness at or towards the middle of the crown, so that the crown when the staple is driven in, is below the surface of the sheet or panel and so that the crown is flush with the surface. A staple driving and setting machine may be used for driving the staples in to the board and frame structure.

Document U.S. Pat. No. 5,846,019A discloses a prior art fastener system, comprising a U-shaped fastener element, which is configured to be driven into a workpiece by means of driving element in a driving tool. A pair of projections on the driving element are configured to contact the U-shaped fastener element and concentrate the driving force directly over the legs of the U-shaped fastener element rather than along the whole linear length of the front edge of the driving element.

### SUMMARY

Even though there are known fastener elements, which are configured to save the paper surface of the gypsum boards from scarring or tearing, these fastener elements may have a tendency to crack and crumble the gypsum in a gypsum or plaster board.

Arranging projections on the driving element may countersink the faster element into the workpiece. The projections may also result in forces, which are urging the upper parts of the legs of the U-shaped element towards each other. This may crack and crumble the gypsum in a gypsum or plaster board.

A further problem with the known solutions using staples for fixating boards to a frame structure is that the staples may have a tendency to be pushed out of the frame structure and the boards due to fluctuations moisture content of the frame structure, which may result in that the boards may release from the frame structure.

There is thus a need for an improved fastener element for fixating boards to a frame structure, a tool for driving a fastener element into boards and a frame structure, and a fastener system for fastening boards to a frame structure.

It is an object of the present disclosure to mitigate, alleviate or eliminate one or more of the above-identified deficiencies and disadvantages in the prior art and solve at least the above-mentioned problems.

An objective problem to be solved by the present disclosure is to achieve a fastener element, a tool and a fastener system which at least partly preserve the structure of the board under a head of the fastener element and preserves the bearing capacity of the board under the head of the fastener element.

A further objective problem to be solved by the present disclosure is to achieve a fastener element, a tool and a fastener system in which the fastener element is driven and retained into the boards and frame structure for retaining the boards on the frame structure.

These objectives are achieved with the above-mentioned fastener element for fixating boards to a frame structure, the tool for driving a fastener element into boards and a frame structure, and the fastener system for fastening boards to a frame structure according to the appended claims.

According to a first aspect there is provided a fastener element for fixating boards to a frame structure, the fastener element comprises: a pair of legs each comprising a first end and a second end, and a head, which extends between the legs and which is connected to the first end of each leg, wherein the head of the fastener element has a straight extension, which during a fastening operation, for driving of the fastener element into the board and frame structure, is ductile to a convex arch-shape; wherein the convex arch-shape of the head has a curved path along the entire extension of the head, and wherein a distance between any point on the head and the second end of each leg increases during the fastening operation.

The fastener element may be configured to fixate one board to the frame structure. Both legs of the fastener element thus penetrate the board and into the frame structure. The fastener element may be configured to fixate two boards, one on top of the other, to the frame structure. Both legs of the faster element may thus penetrate both of the boards and into the frame structure. The fastener element may be configured to fixate two boards, arranged side by side to each other, to the frame structure. One of the legs of the fastener element may penetrate one of the boards and into the frame structure. The other leg of the fastener element may penetrate the other board and into the frame structure.

The fastener elements may have strong fixating characteristics in order to retain, secure and fixate the boards on the frame structure. The legs of the fastener element may have a large resistance to be pulled out of the frame structure. The boards may be gypsum boards, plaster boards, fiber boards or plywood boards. The fastener elements are allowed to penetrate the board from one side to the other. The frame structure may be a wooden, steel and/or plastic framework. The fastener elements are allowed to penetrate the frame structure made of wood, steel and/or plastic. The frame structure may comprise vertically arranged wooden studs, which are connected to horizontal steel beams. Such frame structure may together with the boards constitute a wall.

The pair of legs of the fastener element may be arranged in parallel. The legs may have a rectangular or round cross-section. The legs may have a flat or sharp end point. The flat or sharp end points of the legs are configured to lead the legs of the fastener element through the boards and the frame structure.

The head of the fastener element may be configured to at least partly preserve the structure of the board under the head and to preserve the bearing capacity of the board under the head. The head may be driven into the board so that the head is recessed slightly below the surface of the board. A depression is thus created in the surface of the board at the position of the head of the fastener element. Thereafter, a filler may be worked into the depression to provide a smooth surface of the board.

The head may extend between the legs of the fastener element, so that the head together with the legs has a U-shape and is shaped as a staple. The head and legs of the fastener element may be made in one single piece, such as a piece of flat or rounded wire. The single piece of wire may be bent approximately 90 degrees at two positions in order to create the two legs and the head. Thus, the head is connected to the legs. The fastener element may be made of three pieces, a head and two legs, wherein the head is connected to the legs by a suitable connecting method. The head may have a straight extension between the legs. The ends of the straight extended head may meet the ends of the legs in a middle point in the transition between the head and the legs. The straight extension may be slightly curved. The head of the fastener element may be ductile, so that the straight extension of the head may be reshaped to a convex arch-shape. The convex arch-shaped head may at least partly preserve the structure of the board under the head, so that the bearing capacity of the board under the head may be preserved. The fastening operation, for driving of the fastener element into the board and frame structure may be performed by a tool comprising a driving element, which is configured to act with a force on the fastener element, for driving the fastener element into the board and the frame structure. The convex arch-shape of the head may have a curved path along the entire extension of the head. The head extends between the legs. The curved path of the convex arch-shape may extend from a connection point of the head with one of the legs to a connection point of the head with the other leg. The curved path is continuous and can have the shape of a part of a circle or an ellipse. The distance between any point on the head and the second end of each leg may increase during the fastening operation. Thus, the head may bulging in a direction which may result in a distance increase between the point on the head and the second end of the legs. This will define the convex arch-shape of the head.

The convex arch-shape of the head, which has a curved path along the entire extension of the head is formed by a driving element comprising a concave arch-shaped abutment surface with a curved path along the entire extension of the abutment surface. A tool may be used to driving the fastener element into the board and frame structure. The tool or a part of the tool may have a shape, which is configured to create the arch-shape of the head when driving the fastener element. The tool may comprise a driving element, which abuts end exerts a force on the head of the fastener element. The force may drive the fastener element into the fixating board and frame structure and simultaneously create the convex arch-shape of the head. The force from the driving element may create the convex arch-shape of the head. The fastener may comprise a material, which allows the head of the fastener element to be ductile to a convex arch-shape. The concave arch-shaped abutment surface of the driving element, with a curved path along the entire extension of the abutment surface of the driving element may deform the head of the fastener element. The deformation of the head of the fastener element may be complementary to the shape of the concave arch-shaped abutment surface of the driving element. The curved path along the entire extension of the abutment surface of the fastener element may create a complementary shape of the head of the fastener element, which preserves the gypsum in the plaster board.

A distance between an imaginary line, which extends between end portions of the head and a point on the curve or arch-shape of the convex arch-shaped head, which is at the largest perpendicular distance from the imaginary line is in the range of 1 mm to 3 mm, preferably in the range of 1.5 mm to 2.5 mm. The curvature of the convex arch-shape of the head of the fastener element may be related to the length of the head. The definition of the curvature of the convex arch-shape of the head of the fastener element is herein the length of the head in relation to a distance between an imaginary line, which extends between the ends of the head and a point on the curve of the convex arch-shaped head, which is at the largest perpendicular distance from the imaginary line. According to an example, the distance between the imaginary line, which extends between the ends of the head and a point on the curve of the convex arch-shaped head, which is at the largest perpendicular distance from the imaginary line, may be in the range of 1 mm to 3 mm, preferably in the range of 1.5 mm to 2.5 mm. When the length of the head is in the range of 15 mm to 35 mm, preferably in the range of 20 mm to 30 mm, the curvature of the convex arch-shaped head may be in the range of 15/3 to 35/1, preferably in the range of 20/2.5 to 30/1.5. The convex arch-shape of the head within these ranges may at least partly preserve the structure of the board under the head, so that the bearing capacity of the board under the head may be preserved.

According to an example, the head of the fastener element is ductile to an arch-shape with a curvature of the convex arch-shaped head in the range of 15/3 to 35/1, preferably in the range of 20/2.5 to 30/1.5.

The length of each leg may be in the range of 30 mm to 50 mm, preferably in the range of 35 mm to 45 mm. The length of each leg within these ranges may be useful when the fastener element may be configured to fixate two boards, one on top of the other, to the frame structure. Both legs of the faster element may thus penetrate both of the boards and into the frame structure. The fastener elements with legs having a length within these ranges may have strong fixating characteristics in order to retain, secure and fixate the boards on the frame structure. Further, the fastener elements with legs having a length within these ranges may have a large resistance to be pulled out of the frame structure.

The length of each leg may be in the range of 20 mm to 40 mm, preferably in the range of 25 mm to 35 mm. Having a length of each leg within these ranges is of importance when the fastener element is configured to fixate one board to the frame structure. Both legs of the fastener element thus penetrate the board and into the frame structure. The fastener elements with legs having a length within these ranges have strong fixating characteristics as they improve the ability to retain, secure and fixate the boards on the frame structure. Further, the fastener elements with legs having a length within these ranges may have a large resistance to be pulled out of the frame structure.

The length of the head may be in the range of 15 mm to 35 mm, preferably in the range of 20 mm to 30 mm. The length of the head within these ranges may at least partly preserve the structure of the board under the head and to preserve the bearing capacity of the board under the head. Further, the length of the head within these ranges may allow the head of the fastener element to be ductile to an convex arch-shape.

The legs may be coated with an adhesive, which is configured to melt by friction heat induced when driving the fastener element into the board and frame structure. The adhesive coated on the legs may increase the fixating characteristics of the fastener element in order to retain, secure and fixate the boards on the frame structure. Further, the adhesive coated on the legs may increase the resistance of the fastener element to be pulled out of the frame structure.

The legs and the head of the fastener element may have a rectangular cross-section with a thickness in the range of 0.7 mm to 1 mm, preferably in the range of 0.8 mm to 0.9 mm. The fastener element provided with such legs and head may be stable when driving the fastener element into the boards and the frame structure. Thus, the legs may withstand the forces of the driving element and remain straight. Further, the head with a rectangular cross-section with a thickness within these ranges may be ductile to an convex arch-shape.

The second end of each leg may comprise a sharp point, which may be shaped by an inclined surface in relation of the longitudinal extension of each leg. The surface may have an inclination with an angle in the range of 30°-60°, preferably in the range of 40°-50°, and most preferably with an angle of 45° in relation to the longitudinal extension of the leg. This configuration of such a sharp point can penetrate plaster boards and a frame structure. The frame structure may be a wooden, steel and/or plastic framework. The fastener elements provided are allowed to penetrate the frame structure made of wood, steel and/or plastic.

According to a second aspect there is provided a tool for driving a fastener element into boards and a frame structure, the tool comprises a driving element, which is configured to act with a force on the fastener element, for driving the fastener element into a board and a frame structure, wherein the driving element comprises a concave arch-shaped abutment surface with a curved path along the entire extension of the abutment surface, which is configured to bear on a head of the fastener element and to create a convex arch-shape of the head with a curved path along the entire extension of the head by forcing the head to abut and follow the shape of the concave arch-shaped abutment surface of the driving element. The head may be ductile to a convex arch-shape when driving the fastener element into the board and frame structure. The driving element of the tool is configured to create the convex arch-shape of the head when driving the fastener element into the board and frame structure. The fastener may comprise a material, which allows the head of the fastener element to be ductile to a convex arch-shape. The tool may be a pneumatically or electrically driven tool. The tool may comprise a magazine for fastener elements. The tool may be a handheld tool. The tool may be arranged on a robot arm and be controlled by a control device.

The tool may be configured to drive the fastener element disclosed herein into boards and a frame structure. The tool may be designed to drive the fastener elements with the herein disclosed features. The magazine of the tool may be adapted to feed the fastener elements disclosed herein to the driving element of the tool.

According to a third aspect there is provided a fastener system for fastening boards to a frame structure, the system comprising: a fastener element configured to fixate the board to the frame structure; and a tool configured to drive the fastener element into the board and frame structure; wherein the fastener element comprises a pair of legs, configured to penetrate the board and the frame structure; and a head, which extends between the legs and which is connected to the legs; and wherein the tool comprises a driving element, configured to act with a force on the head for driving the fastener element into the board and the frame structure. The driving element comprises a concave arch-shaped abutment surface with a curved path along the entire extension of the abutment surface, which is configured to bear on the head when the legs penetrate the board and frame structure, and to create a convex arch-shape of the head with a curved path along the entire extension of the head, which correspond to the concave arch-shape of the concave arch-shaped abutment surface of the driving element, when the fastener element fixates the board to a frame structure.

The driving element may be blade-shaped, with a thickness corresponding to the thickness of the fastener element and a width corresponding to the length of the head of the fastener element. Thus, the thickness of the driving element may be in the range of 0.7 mm to 1 mm, preferably in the range of 0.8 mm to 0.9 mm. The width of the driving element may be in the range of 15 mm to 35 mm, preferably in the range of 20 mm to 30 mm. The width of the driving element corresponds to the distance between two side edges of the driving element. The side edges may extend in parallel to each other. A front portion of the driving element is arch-shaped, with an concave arch-shaped surface extending from one side edge to the other side edge. The concave arch-shaped surface of the front portion of the driving element constitutes the concave arch-shaped abutment surface. The concave arch-shaped abutment surface may have a symmetric concave arch-shape or an asymmetric concave arch-shape. The concave arch-shaped abutment surface may be smooth or may be provided with a pattern.

The fastener system comprises the herein disclosed fastener element and the tool for driving the fastener element into boards and a frame structure.

The fastener element of the fastener system may be configured to fixate one board to the frame structure. Both legs of the fastener element thus penetrate the board and into the frame structure. The fastener element of the fastener system may be configured to fixate two boards, one on top of the other, to the frame structure. Both legs of the faster element may thus penetrate both of the boards and into the frame structure. The fastener element of the fastener system may be configured to fixate two boards, arranged side by side to each other, to the frame structure. One of the legs of the fastener element may penetrate one of the boards and into the frame structure. The other leg of the fastener element may penetrate the other board and into the frame structure.

The tool of the fastener system comprises a driving element, which is configured to act with a force on the fastener element, for driving the fastener element into a board and a frame structure. The acting force of the driving element may be an impact force of a punch force. The impact force may be similar to a force, which is exerted by a hammer. The punch force is similar to a force, which is exerted by a press machine. The driving element comprises a concave arch-shaped abutment surface, which is configured to bear on the head of the fastener element and to create a convex arch-shape of the head. The created convex arch-shape of the head may correspond to the concave arch-shape of the concave arch-shaped abutment surface of the driving element. The head may be ductile to a convex arch-shape when driving the fastener element into the board and frame structure. The driving element of the tool is configured to create the convex arch-shape of the head when driving the fastener element into the board and frame structure. The fastener may comprise a material, which allows the head of the fastener element to be ductile to a convex arch-shape. The driving element may be blade-shaped, with a thickness corresponding to the thickness of the fastener element and a width corresponding to the length of the head of the fastener element. Thus, the thickness of the driving element may be in the range of 0.7 mm to 1 mm, preferably in the range of 0.8 mm to 0.9 mm. The width of the driving element may be in the range of 15 mm to 35 mm, preferably in the range of 20 mm to 30 mm. The width of the driving element corresponds to the distance between two side edges of the driving element. The side edges may extend in parallel to each other. A front portion of the driving element is concave arch-shaped, with an concave arch-shaped surface extending from one side edge to the other side edge. The concave arch-shaped surface of the front portion of the driving element constitutes the concave arch-shaped abutment surface. The concave arch-shaped abutment surface may have a symmetric concave arch-shape or an asymmetric concave arch-shape. The concave arch-shaped abutment surface may be smooth or may be provided with a pattern. The tool may be a pneumatically or electrically driven tool. The tool may comprise a magazine for fastener elements. The tool may be a handheld tool. The tool may be arranged on a robot arm and be controlled by a control device.

The head of the fastener element may have a straight extension before the fastener element has been driven into the board and frame structure. The head may extend between the legs of the fastener element, so that the head together with the legs has a U-shape and is shaped as a staple. The head and legs of the fastener element may be made in one single piece, such as a piece of flat or rounded wire. The single piece of wire may be bent approximately 90 degrees at two positions in order to create the two legs and the head. Thus, the head is connected to the legs. The fastener element may be made of three pieces, a head and two legs, wherein the head is connected to the legs by a suitable connecting method. The head may have a straight extension between the legs. The straight extension may be slightly curved. The head of the fastener element may be ductile, so that the straight extension of the head may be reshaped to a convex arch-shape. The convex arch-shaped head may at least partly preserve the structure of the board under the head, so that the bearing capacity of the board under the head may be preserved.

A distance between an imaginary line, which extends between the side edges at the front portion of the driving element and a point on a curve or arch-shape of the concave arch-shaped abutment surface, which is at the largest perpendicular distance from the imaginary line is in the range of 1 mm to 3 mm, preferably in the range of 1.5 mm to 2.5 mm. The concave arch-shaped abutment surface of the driving element with such a distance between an imaginary line, which extends between the side edges at the front portion of the driving element and a point on a curve of the concave arch-shaped abutment surface, which is at the largest perpendicular distance from the imaginary line within these ranges may create a convex arch-shape of the head of the fastener element with a distance between an imaginary line, which extends between end portions of the head and a point on the curve of the convex arch-shaped head, which is at the largest perpendicular distance from the imaginary line in the range of 1 mm to 3 mm, preferably in the range of 1.5 mm to 2.5 mm. The convex arch-shape of the head within these ranges may at least partly preserve the structure of the board under the head, so that the bearing capacity of the board under the head may be preserved. The curvature of the concave arch-shaped abutment surface may be related to the width of the driving element. The definition of the curvature is herein the width of the front portion of the driving element in relation to a distance between an imaginary line, which extends between the side edges at the front portion of the driving element and the point on the curve of the concave arch-shaped abutment surface, which is at the largest perpendicular distance from the imaginary line. According to an example, the distance between the imaginary line, which extends between the side edges at the front portion of the driving element and the point on the curve of the concave arch-shaped abutment surface, which is at the largest perpendicular distance from the imaginary line, may be in the range of 1 mm to 3 mm, preferably in the range of 1.5 mm to 2.5 mm. When the width of the driving element is in the range of 15 mm to 35 mm, preferably in the range of 20 mm to 30 mm, the curvature of the concave arch-shaped abutment surface may be in the range of 15/3 to 35/1, preferably in the range of 20/2.5 to 30/1.5.

According to an example, the arch-shape of the concave arch-shaped abutment surface of the driving element has a curvature in the range of 15/3 to 35/1, preferably in the range of 20/2.5 to 30/1.5.

The length of each leg may be in the range of 30 mm to 50 mm, preferably in the range of 35 mm to 45 mm. The length of each leg within these ranges may be useful when the fastener element may be configured to fixate one board to the frame structure. Both legs of the fastener element thus penetrate the board and into the frame structure. The fastener elements with legs having a length within these ranges may have strong fixating characteristics in order to retain, secure and fixate the boards on the frame structure. Further, the fastener elements with legs having a length within these ranges may have a large resistance to be pulled out of the frame structure.

The length of each leg may be in the range of 20 mm to 40 mm, preferably in the range of 25 mm to 35 mm. The length of each leg within these ranges may be useful when the fastener element may be configured to fixate one board to the frame structure. Both legs of the fastener element thus penetrate the board and into the frame structure. The fastener elements with legs having a length within these ranges may have strong fixating characteristics in order to retain, secure and fixate the boards on the frame structure. Further, the fastener elements with legs having a length within these ranges may have a large resistance to be pulled out of the frame structure.

The length of the head may be in the range of 15 mm to 35 mm, preferably in the range of 20 mm to 30 mm. The length of the head within these ranges may at least partly preserve the structure of the board under the head and to preserve the bearing capacity of the board under the head. Further, the length of the head within these ranges may allow the head of the fastener element to be ductile to a convex arch-shape.

The legs may be coated with an adhesive, which is configured to melt by friction heat induced when driving the fastener element into the board and frame structure. The adhesive coated on the legs may increase the fixating characteristics of the fastener element in order to retain, secure and fixate the boards on the frame structure. Further, the adhesive coated on the legs may increase the resistance of the fastener element to be pulled out of the frame structure.

The frame structure may comprise at least one stud, which comprises a first and a second flange portion and a web portion interconnecting the flange portions. Such stud may be a building stud for forming a framework for mounting wall panels. Each flange portion may comprise a planar, elongated wood fiber member. The web portion may comprise a sheet metal member, which sheet metal member may be foldable to enable folding the building stud from a retracted storage position to an expanded mounting position. The joint between the attachment sections and the respective flange member may be a nail joint, a screw joint, a glue joint or a combination thereof.

The length of each leg of the fastener element may be larger than the sum of the thickness of the board and the thickness of one of the first or second flange portions. Such an arrangement may result in the tip or point of the respective leg of the fastener element protrudes from the first or second flange portions. An advantage of such an arrangement is that the fastener element may be retained and secured in the first or second flange portion of the stud without being forced and pushed out of the stud due to changed properties of the stud, such as reduced moisture content in a wooden stud or a stud comprising wood flange portions.

The board may be a gypsum board provided with paper surfaces, wherein at least a part of the gypsum structure of the gypsum board may have a bearing capacity under the head of the fastener element when the fastener element has been driven into the board and frame structure. The gypsum board may comprise a layer of generally porous, frangible dry gypsum plaster between two reinforcing and protective facings or skins of paper. The convex arch-shaped head of the fastener element may preserve at least a part of frangible dry gypsum plaster under the head from crushing and thus keep the bearing capacity of the gypsum board under the head of the fastener element. As a result, the fastener element may retain and secure the gypsum board on the frame structure.

Effects and features of the second and third aspects are to a large extent analogous to those described above in connection with the first aspect. Embodiments mentioned in relation to the first aspect are largely compatible with the second and third aspects.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 schematically illustrates in a sectional view, a fastener system for fastening boards to a frame structure according to an example;

FIG. 2 schematically illustrates in a side view, a fastener element according to an example;

FIG. 3 schematically illustrates a sectional view along line A-A in FIG. 1 according to an example;

FIG. 4 schematically illustrates a sectional view along line A-A in FIG. 1 according to an example;

FIG. 5 schematically illustrates in a side view, boards fastened to a frame structure according to an example;

FIG. 6a schematically illustrates in a side view, a fastener element according to an example;

FIG. 6b schematically illustrates in a side view, a driving element of a tool according to an example;

FIGS. 7a and 7b schematically illustrate in side views, a fastener element before and after driving by a tool according to an example; and

FIGS. 8a and 8b schematically illustrate in side views, a tool according to an example.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

FIG. 1 schematically illustrates in a sectional view, a fastener system 1 for fastening boards 2 to a frame structure 4. A fastener element 6 is configured for fixating the boards 2 to a frame structure 4. A tool 8 is configured to drive the fastener element 6 into the board 2 and frame structure 4.

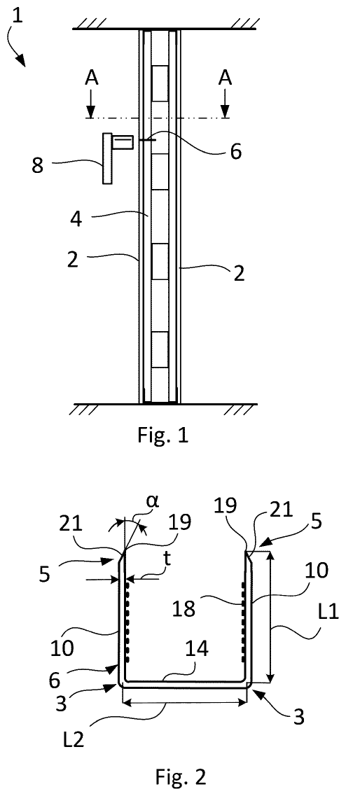

FIG. 2 schematically illustrates in a side view, a fastener element 6, which comprises a pair of legs 10, each having a length L1 and a head 14 with a length L2. Each leg 10 comprises a first end 3 and a second end 5. The head 14 extends between the legs 10 and the head 14 is connected to the legs 10. The ends of the head 14 and the first end 3 of each leg 10 meets in a middle point at the connection between the head 14 and legs 10. The head 14 of the fastener element 6 has a straight extension and is ductile to a convex arch-shape for increased bearing resistance when driven into the board 2 and frame structure 4.

The length L1 of each leg 10 may in one example be in the range of 30 mm to 50 mm, preferably in the range of 35 mm to 45 mm. The length of each leg 10 within these ranges may be useful when the fastener element 6 may be configured to fixate two boards 2, one on top of the other, to the frame structure 4. According to another example, the length L1 of each leg 10 is in the range of 20 mm to 40 mm, preferably in the range of 25 mm to 35 mm. The length of each leg 10 within these ranges may be useful when the fastener element 6 may be configured to fixate one board 2 to the frame structure 4. The legs 10 and the head 14 of the fastener element 6 may have a rectangular cross-section with a thickness t in the range of 0.7 mm to 1 mm, preferably in the range of 0.8 mm to 0.9 mm. The length L2 of the head 14 is in the range of 15 mm to 35 mm, preferably in the range of 20 mm to 30 mm. The legs 10 may be coated with an adhesive 18, which is configured to melt by friction heat induced when driving the fastener element 6 into the board 2 and frame structure 4. The second end 5 of each leg 10 may comprise a sharp point 19, which may be shaped by an inclined surface 21 in relation of the longitudinal extension of each leg 10. The surface 21 may have an inclination with an angle a in the range of 30°-60°, preferably in the range of 40°-50°, and most preferably with an angle of 45° in relation to the longitudinal extension of the leg 10.

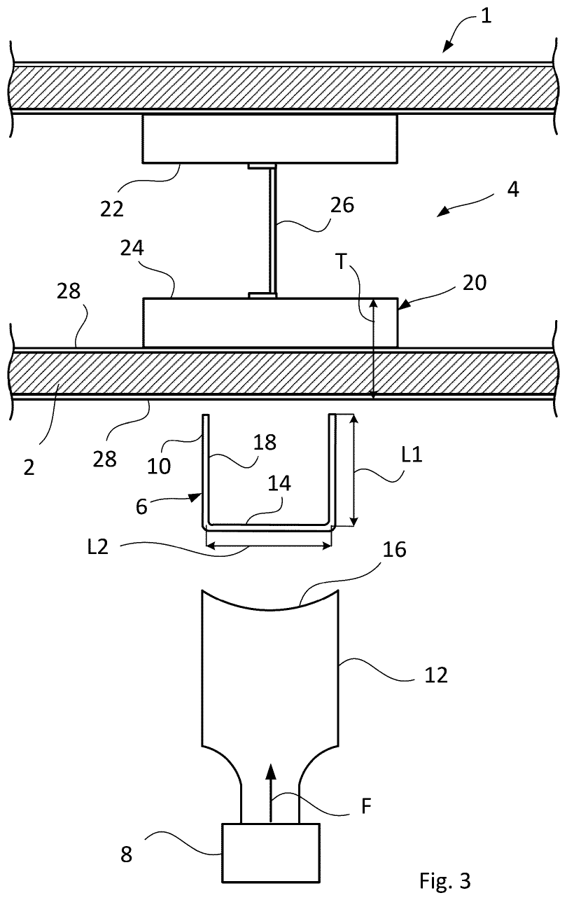

FIG. 3 schematically illustrates a sectional view along line A-A in FIG. 1 according to an example. A fastener element 6 is ready to fixate the board 2 to the frame structure 4. A schematically disclosed tool 8 is ready to drive the fastener element 6 into the board 2 and frame structure 4. The tool 8 comprises a driving element 12, configured to act with a force F on the head 14 of the fastener element 6 for driving the fastener element 6 into the board 2 and the frame structure 4. The driving element 12 comprises a concave arch-shaped abutment surface 16, which is configured to bear on the head 14 when the legs 10 penetrate the board 2 and frame structure 4. The head 14 of the fastener element 6 has a straight extension before the fastener element 6 has been driven into the board 2 and frame structure 4.

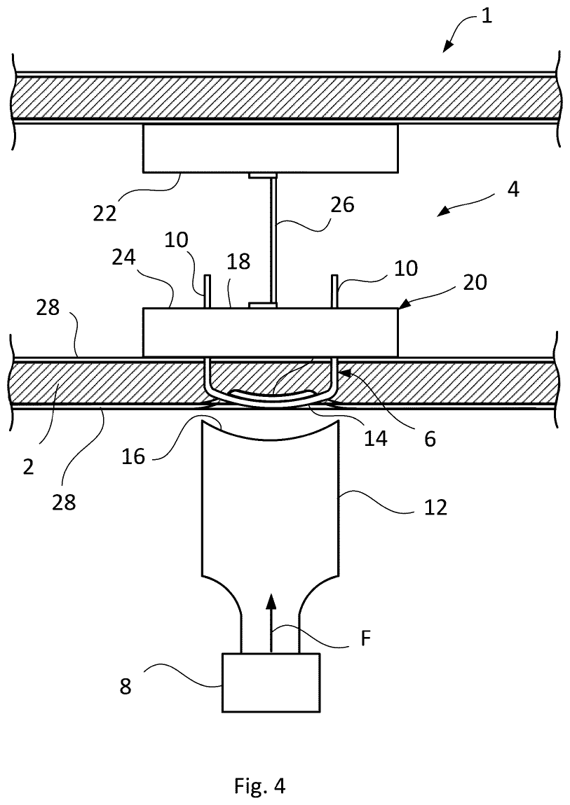

FIG. 4 schematically illustrates a sectional view along line A-A in FIG. 1 according to an example. In FIG. 4, the fastener element 6 has been driven in to the board 2 and in to the frame structure 4. The concave arch-shaped abutment surface 16 of the driving element 12 has created a convex arch-shape of the head 14, which correspond to the arch-shape of the concave arch-shaped abutment surface 16 of the driving element 12, when the fastener element 6 fixates the board 2 to a frame structure 4. The head 14 is ductile to a convex arch-shape when driving the fastener element 6 into the board 2 and frame structure 4.

The frame structure 4 comprises a stud 20, which comprises a first and a second flange portion 22, 24 and a web portion 26 interconnecting the flange portions 22, 24. The length L1 of each leg 10 of the fastener element 6 is larger than the sum of the thickness T of the board 2 and the thickness of one of the first or second flange portions 22, 24. The board 2 may be a gypsum board 2 provided with paper surfaces 28, wherein at least a part of the gypsum structure of the gypsum board 2 has a bearing capacity under the head 14 of the fastener element 6 when the fastener element 6 has been driven into the board 2 and frame structure 4.

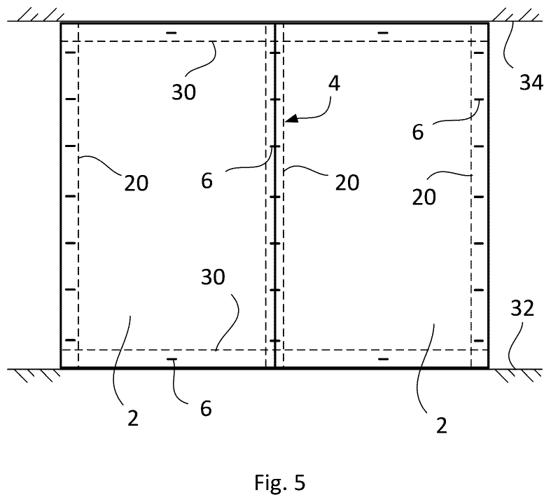

FIG. 5 schematically illustrates in a side view, two boards 2 fastened side by side to a frame structure 4 according to an example. The frame structure 4 in FIG. 5 comprises three vertically arranged studs 20 and two horizontally arranged U-beams. The studs 20 may be building studs 20 comprising first and a second flange portions 22, 24, and a web portion interconnecting the flange portions 22, 24 for forming a framework for mounting wall panels. The U-beams may be made of steel. One of the U-beams 30 is firmly connected to the floor 32 and the other U-beam 30 is firmly connected to the ceiling 34. At the adjacent end sides of the boards 2, the boards 2 are connected to the same stud 20 by fastening elements 6. One of the legs 10 of the fastener element 6 may penetrate one of the boards 2 and into the vertically arranged stud 20 of the frame structure 4. The other leg 10 of the fastener element 6 may penetrate the other board 2 and into the vertically arranged stud 20 of the frame structure 4. The boards 2 are at their other end side connected to the vertically arranged studs 20 by fastener elements 6. Further, the boards 2 are connected to the U-beams 30 by the fastener elements 6.

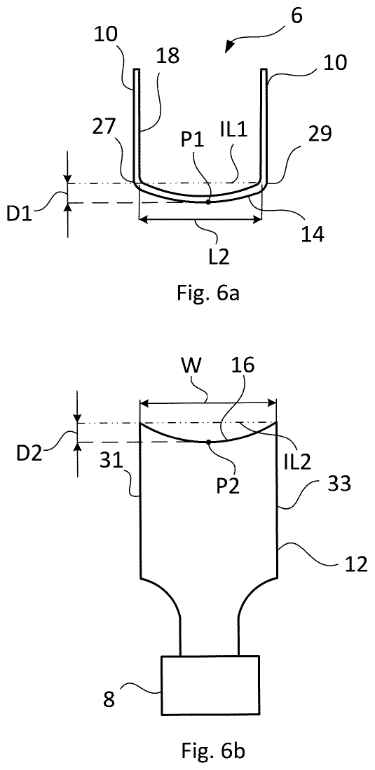

FIG. 6a schematically illustrates in a side view, a fastener element 6 according to an example. The head 14 of the fastener element 6 has a convex arch-shape, which is created by the concave arch-shaped abutment surface 16 of the driving element 12. A distance D1 between an imaginary line IL1, which extends between end portions 27, 29 of the head 14 and a point P1 on the curve or arch-shape of the convex arch-shaped head 14, which is at the largest perpendicular distance from the imaginary line IL1 is in the range of 1 mm to 3 mm, preferably in the range of 1.5 mm to 2.5 mm. The curvature of the convex arch-shape of the head 14 of the fastener element 6 may be related to the length L2 of the head 14. The definition of the curvature of the convex arch-shape of the head 14 of the fastener element 6 is herein the length L2 of the head 14 in relation to the distance D1 between the imaginary line IL1, which extends between the end portions 27, 29 of the head 14 and the point P1 on the curve or arch-shape of the convex arch-shaped head 14, which is at the largest perpendicular distance from the imaginary line IL1.

FIG. 6b schematically illustrates in a side view, a driving element 12 of a tool 8 according to an example. The driving element 12 is provided with the concave arch-shaped abutment surface 16, which is configured to bear on a head 14 of the fastener element 6 and to create a convex arch-shape of the head 14. The driving element 12 is blade-shaped, with a thickness corresponding to the thickness of the fastener element 6 and a width W corresponding to the length L2 of the head 14 of the fastener element 6. The width W of the driving element 12 corresponds to the distance between two side edges 31, 33 of the driving element 12. The side edges 31, 33 extend in parallel to each other. The front portion of the driving element is arch-shaped, with a concave arch-shaped abutment surface 16 extending from one side edge 31 to the other side edge 33. The concave arch-shaped abutment surface 16 has a symmetric concave arch-shape. The curvature of the concave arch-shaped abutment surface 16 may be related to the width W of the driving element 12. The definition of the curvature is herein the width W of the front portion of the driving element 12 in relation to a distance D2 between an imaginary line IL2, which extends between the side edges 31, 33 at the front portion of the driving element 12 and the point P2 on the curve or arch-shape of the concave arch-shaped abutment surface 16, which is at the largest perpendicular distance D2 from the imaginary line IL2.

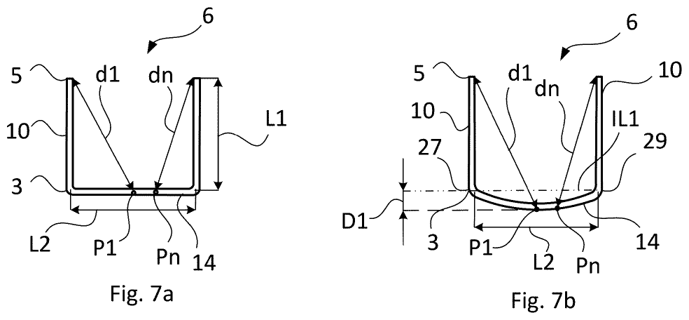

FIGS. 7a and 7b schematically illustrate in side views, a fastener element before and after driving by a tool according to an example. In FIG. 7a the fastener element has an origin shape before it has been driven into a work piece. The head 14 of the fastener element 6 has a straight extension. Each leg 10 has a first end 3 and a second end 5, and a head 14, which extends between the legs 10 and which is connected to the first end 3 of the legs 10. During the fastening operation of the fastener element 6 the head 14 is ductile to a convex arch-shape shown in FIG. 7b. The distance D1 between an imaginary line IL1, which extends between end portions 27, 29 of the head 14 and a point P1 on the curve or arch-shape of the convex arch-shaped head 14. In FIG. 7b the imaginary line IL1 correspond to the straight extension of the head 14 shown in FIG. 7a. The convex arch-shape of the head 14 has a curved path along the entire extension of the head 14. A distance d1, dn between any point P1, Pn on the head 14 and the second end 5 of each leg 10 increases during the fastening operation. The length L1 of the legs 10 and the width of L2 of the fastener element 6 are the same before and after driving the fastener element 6 into a work piece.

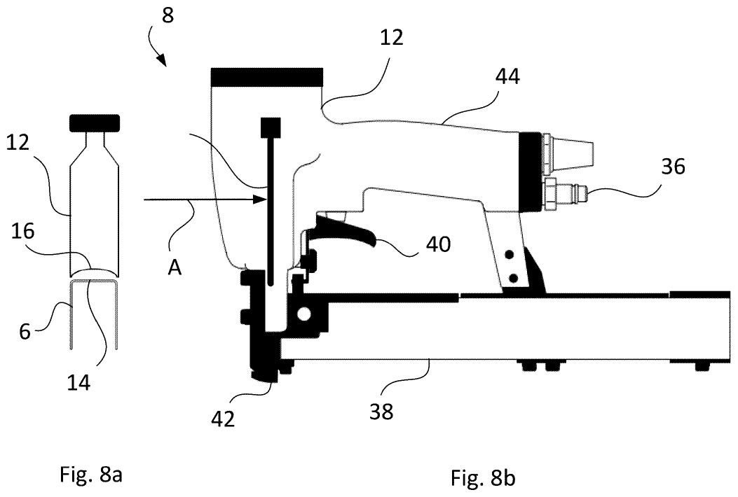

FIGS. 8a and 8b schematically illustrate in side views, a tool 8 according to an example. FIG. 8a illustrates the driving element 12, which is configured to act with a force F on the fastener element 6, for driving the fastener element 6 into a board 2 (FIG. 5) and a frame structure 4 (FIG. 5). The driving element 12 is comprised in the tool 8 illustrated in FIG. 8b. An arrow A between FIGS. 8a and 8b indicates the position of the driving element 12 in the tool 8. The driving element 12 disclosed in FIG. 8b is disclosed in a 90° side view in relation to the disclosed driving element 12 in FIG. 8a. The driving element 12 is provided with the concave arch-shaped abutment surface 16, which is configured to bear on a head 14 of the fastener element 6 and to create a convex arch-shape of the head 14. The tool 8 is pneumatically driven and comprises a hose connection 36 for pneumatic supply. The tool 8 comprises a magazine 38 for fastener elements 6. By influencing the tool 8 with a push button 40, pneumatic air pushes the driving element 12 in the direction of a fastener element 6 in the magazine. The fastener element 6 will by the force from the driving element 12 be pushed out of a nozzle 42 of the tool 8 and further into the board 2 and frame structure 4. The tool 8 in FIG. 8b is a hand held tool 8 provided with a handle 44.

The person skilled in the art realizes that the present disclosure is not limited to the preferred embodiments described above. The person skilled in the art further realizes that modifications and variations are possible within the scope of the appended claims. Additionally, variations to the disclosed embodiments can be understood and effected by the skilled person in practicing the claimed disclosure, from a study of the drawings, the disclosure, and the appended claims.

1. A fastener element for fixating boards to a frame structure, the fastener element comprises:
a pair of legs each comprising a first end and a second end; and
a head, which extends between the pair of legs and which is connected to the first end of each leg; of the pair of legs,
wherein the head of the fastener element comprises a straight extension, which is ductile to a convex arch-shape for driving of the fastener element into a board and a frame structure; during a fastening operation,
wherein the convex arch-shape of the head comprises a curved path along an entire extension of the head, and
wherein a distance between any point on the head and the second end of each leg of the pair of legs increases during the fastening operation.

2. The fastener element according to claim 1, wherein the convex arch-shape of the head is formed by a driving element comprising a concave arch-shaped abutment surface with a curved path along an entire extension of the concave arch-shaped abutment surface.

3. The fastener element according to claim 2, wherein a distance between an imaginary line, which extends between end portions of the head and a point on a curve of the convex arch-shaped head, and which is measured at a largest perpendicular distance from the imaginary line, is in the range of 1 mm to 3 mm.

4. The fastener element according to claim 2, wherein a curvature of the convex arch-shaped head is in the range of 15/3 to 35/1.

5. The fastener element according to claim 1, wherein the a length of each leg of the pair of legs is in the range of 30 mm to 50 mm.

6. The fastener element according to claim 1, wherein a length of each leg of the pair of legs is in the range of 20 mm to 40 mm.

7. The fastener element according to claim 1, wherein a length of the head is in the range of 15 mm to 35 mm.

8. The fastener element according to claim 1, wherein the pair of legs is coated with an adhesive, which is configured to melt by friction heat induced when driving the fastener element into the board and the frame structure.

9. The fastener element according to claim 1, wherein the pair of legs and the head of the fastener element comprise a rectangular cross-section with a thickness in the range of 0.7 mm to 1 mm.

10. The fastener element according to claim 1, wherein the second end of each leg of the pair of legs comprises a sharp point, which is shaped by an inclined surface in relation to a longitudinal extension of each leg of the pair of legs.

11. A tool for driving a fastener element into boards and a frame structure, the tool comprising:
a driving element, which is configured to act with a force on the fastener element, for driving the fastener element into a board and a frame structure,
wherein the driving element comprises a concave arch-shaped abutment surface with a curved path along an entire extension of the concave arch-shaped abutment surface, which is configured to bear on a head of the fastener element and to create a convex arch-shape of the head with a curved path along the an entire extension of the head by forcing the head to abut and follow the a shape of the concave arch-shaped abutment surface of the driving element.

12. A tool configured to drive the fastener element of claim 1 into boards and a frame structure, the tool comprising:
a driving element, which is configured to act with a force on the fastener element, for driving the fastener element into a board and a frame structure,
wherein the driving element comprises a concave arch-shaped abutment surface with a curved path along an entire extension of the concave arch-shaped abutment surface, which is configured to bear on the head of the fastener element and to create the convex arch-shape of the head with the curved path along an entire extension of the head by forcing the head to abut and follow a shape of the concave arch-shaped abutment surface of the driving element.

13. A fastener system for fastening boards to a frame structure, the system comprising:
a fastener element configured to fixate a board to a frame structure; and
a tool configured to drive the fastener element into the board and the frame structure;
wherein the fastener element comprises;
a pair of legs, configured to penetrate the board and the frame structure; and
a head, which extends between the legs and which is connected to the legs, and
wherein the tool comprises a driving element, configured to act with a force on the head for driving the fastener element into the board and the frame structure, and
wherein the driving element comprises a concave arch-shaped abutment surface with a curved path along an entire extension of the concave arch-shaped abutment surface, which is configured to bear on the head when the legs penetrate the board and the frame structure, and to create a convex arch-shape of the head with a curved path along the entire extension of the head, which corresponds to an arch-shape of the concave arch-shaped abutment surface of the driving element, when the fastener element fixates the board to the frame structure.

14. The system according to claim 13, wherein the head of the fastener element comprises a straight extension before the fastener element is driven into the board and the frame structure.

15. The system according to claim 13, wherein a distance between an imaginary line, which extends between side edges at the a front portion of the driving element and a point on a curve of the concave arch-shaped abutment surface, which is measured at the a largest perpendicular distance from the imaginary line is in the range of 1 mm to 3 mm.

16. The system according to claim 13, wherein an arch-shape of the concave arch-shaped abutment surface of the driving element comprises a curvature in the range of 15/3 to 35/1.

17. The system according to claim 13, wherein a length of each leg of the pair of legs is in the range of 30 mm to 50 mm.

18. The system according to claim 13, wherein a length of each leg of the pair of legs is in the range of 20 mm to 40 mm.

19. The system according to claim 13, wherein the a length of the head is in the range of 15 mm to 35 mm.

20. The system according to claim 13, wherein the pair of legs are coated with an adhesive, which is configured to melt by friction heat induced when driving the fastener element into the board and the frame structure.

21. The system according to claim 13, wherein the frame structure comprises at least one stud, which comprises a first and a second flange portion and a web portion interconnecting the first and the second flange portion.

22. The system according to claim 21, wherein a length of each leg of the pair of legs of the fastener element is larger than a sum of a thickness of the board and a thickness of one of the first or the second flange portion.

23. The system according to claim 13, wherein the board comprises a gypsum board provided with paper surfaces, wherein at least a part of a gypsum structure of the gypsum board a bearing capacity under the head of the fastener element when the fastener element is driven into the board and the frame structure.
